(19) United States
(12) Patent Application Publication
(10) Pub. No.: US 2002/0025813 A1
(43) Pub. Date: Feb. 28, 2002

(54) Method and device for administering a multiplicity of terminals

(76) Inventors: Bernhard Boehmer, Berlin (DE); Peter Kim, Berlin (DE); Georg Kastelewicz, Berlin (DE); Arnim Vogel, Berlin (DE)

Correspondence Address: Kevin R. Spivak, Morrison & Foerster LLP, Suite 5500, 2000 Pennsylvania Avenue, N.W., Washington, DC, 20006-1888, US

(21) Appl. No.: 09/923,800

(22) Filed: Aug. 8, 2001

(30) Foreign Application Priority Data
Aug. 8, 2000 (EP) 00117011.7

(51) Int. Cl. H04Q 7/20

(52) U.S. Cl. 455/435; 455/412; 455/507

(57) ABSTRACT

A central entity for administering terminals of a user is introduced. Terminals of the respective user register with this entity and leave information on the manner in which applications can interact with them and the methods of information exchange which are supported by them (protocols, data exchange formats, address information). Applications initiating interaction with terminals inquire from the central entity via which terminals a certain user can be reached. As a result of the inquiry, the application (if it is authorized to receive this information) receives a list of the terminals of the user. This list includes address information and information on possible data exchange formats and protocols supported by the terminal for each terminal.

### CLAIM FOR PRIORITY

This application claims priority to European Patent Application No. 00117011.7 filed on Aug. 8, 2000, the disclosure of which is incorporated by reference in its entirety.

### TECHNICAL FIELD OF THE INVENTION

The invention relates to a central entity for administering terminals of a user, and in particular, to information regarding which applications and terminal can interact with one another and the methods of information exchange.

### BACKGROUND OF THE INVENTION

The interest of commercial information providers, usually also called service providers, in data networks such as the Internet has risen dramatically in recent years. This development is primarily due to the flexibility of the exchange of information and the comparably low costs. Thus, for example, it is very simple in the Internet to provide information quickly and inexpensively worldwide, or even to offer completely new services, without interposing a central entity. This is based on the distributed communication architecture of the Internet. However, it is very difficult to enforce uniform guidelines in this type of arrangement.

As data and telephone networks become fused together, a multiplicity of new terminals are suddenly invading the telecommunication market. Examples of this are the WAP (Wireless Access Protocol) terminals which have already been introduced. The continuously increasing demand for greater bandwidths also provides for more and more services, for example also increasingly in the multimedia field.

Users are now contacting the services to which they subscribe not only by means of a single defined terminal, but use the entire variety of new terminals and the associated variety of access technologies. To this is added the fact that a user can simultaneously use a service via different terminals.

This results in a completely new class of applications which are set up for being activated by users from different types of terminals and which perform their services on any terminal of the user.

These applications make new demands on the network infrastructure. For example, an application should be informed about the type of terminal on which it is to perform its service for a user and how it can contact these terminals.

This is a new problem since, as a general rule, the application hitherto only had to be able to intercommunicate with a single terminal of this user. The application knew how it could interact with the terminal. If the application could not do this, there was no was no way of performing the service.

### SUMMARY OF THE INVENTION

In one embodiment of the invention, there is a method for administering terminals in communication networks which includes, for example, registering at least one terminal with a central registration entity, communicating at least one application with the at least one terminal, performing an inquiry at the central registration entity, and performing at least one action on the basis of the result of the inquiry.

In one aspect of the invention, the registering of the terminal with the central registration entity is not carried out by the terminal to be registered.

In another aspect of the invention, the registration information is updated.

In yet another aspect of the invention, the method for administering terminals in communication networks includes, for example, performing the inquiry for the user of the terminals by the application, and supplying a list of terminals allocated to the user back to the application.

In still another aspect of the invention, an interrogation is permitted if the application has authority for the interrogation.

In one aspect of the invention, in the registration information, preferences relating to the terminals are specified, for example, an order of priority in which individual terminals are to be addressed, data formats to transmit voice and/or data to the corresponding terminal, and transmission standards for the transmission.

In another aspect of the invention, the application decides from the registration information supplied back which terminal establishes contact.

In yet another aspect of the invention, the application establishes contact with a number of terminals.

In another embodiment of the invention, there is a device for administering terminals in communication networks which includes, for example, at least one terminal registered with a central registration entity, and at least one application to communicate with the at least one terminal, the application performs an inquiry at the central registration entity, and the application performs at least one action on the basis of the result of the inquiry.

In one aspect of the invention, the registering of the terminal with the central registration entity is not carried out by the terminal to be registered.

In another aspect of the invention, the registration information is updated.

In yet another aspect of the invention, the application performs the inquiry for the user of the terminals, and supplying a list of terminals is allocated to the user is supplied back to the application.

In still another aspect of the invention, an interrogation is permitted if the application has authority for the interrogation.

In one aspect of the invention, in the registration information, preferences relating to the terminals are specified as an order of priority in which individual terminals are to be addressed, data formats to transmit voice and/or data to the corresponding terminal, and transmission standards for the transmission.

In another aspect of the invention, the application decides from the registration information supplied back which terminal establishes contact.

In still another aspect of the invention, the application establishes contact with a number of terminals.

### BRIEF DESCRIPTION OF THE DRAWINGS

In the text which follows, the invention will be explained with reference to exemplary embodiments. In the figures:

FIG. 1 shows the system architecture for the central administration of terminals.

FIG. 2 shows a message flow by way of example.

FIG. 3 shows an exemplary embodiment of a user who uses two terminals and has subscribed to two services.

### DETAILED DESCRIPTION OF THE PREFERRED EMBODIMENTS

The invention enables a user to have a multiplicity of terminals, of different types, and for each to intercommunicate with the application within its capabilities.

In one embodiment, there is a central entity for administering terminals of a user. The terminals of the respective user register with this entity and leave information on the manner in which applications can interact with them and which methods of information exchange are supported by them (protocols, data exchange formats, address information).

Applications initiating an interaction with terminals inquire at the central entity via which terminals a certain user can be reached. As a result of the inquiry, the application (if it is authorized to receive this information) receives a list of the terminals of the user. This list includes address information and information on possible data exchange formats and protocols supported by the terminal for each terminal.

When a user uses a multiplicity of terminals and applications, certain characteristics (descriptions) of these terminals are administered by a central entity. Terminals register their address information and information on possible data exchange formats and protocols at the central entity, and keep this registration information updated.

Applications which intend to contact a user obtain information about the registered terminals of this user from the central entity.

Instead of terminals, other network elements can also handle the registration.

In mobile terminals, the position in a network (address) can vary with time and the access technology can also change when roaming into other network segments. Hence, registered information can also change dynamically. Thus, terminals need to keep their registration information updated.

On the basis of the information signaled back from the central entity, the application can decide whether and by which way it wants to contact the user in question. It selects the terminals in question in accordance with a suitable algorithm and addresses them. The algorithm can also take into consideration settings by the user. These settings are also administered by the central entity and supplied to the applications.

Advantages of a central administration of terminals:

If there is no central administration of terminals, terminals will always have to register with all applications in question. This is very expensive since the number of applications to which a user has subscribed can be very large. These registration mechanisms would have to be set up on every terminal of the user. In addition, each application provider would also have to implement mechanisms for registration which may be different for each type of terminal.

In the case of central administration, the central entity implements the registration interfaces. Terminals register precisely at this central entity known to them. At the same time, applications only need to support the interface to the central entity which can also be easily standardized.

In addition, preferences (e.g. in accordance with aspects of cost relating to the terminals with which the application is to communicate, can also be set up at the central administration (e.g. selection or order of priority of the terminals, preferred data formats and transmission standards).

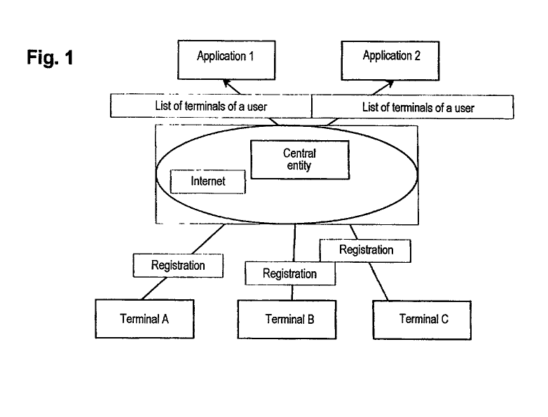

FIG. 1 describes the system architecture for the central administration of terminals. It shows the central entity which can be located in any network, for example the Internet. Terminals A, B, C can register with the entity by means of a registration process, or also deregister. The applications 1, 2 can interrogate information on the registered terminals, for use with the application, from the central entity and then receive back, for example, a list of the registered terminals of a user, depending on the type of application.

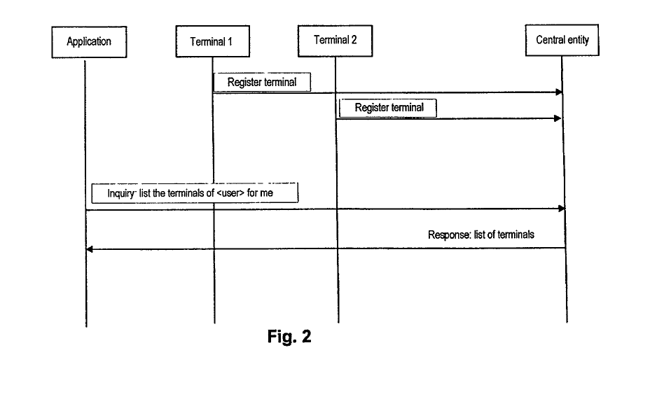

FIG. 2 shows an exemplary flow of messages between the central entity and the terminals, on the one hand, and the applications (for example services), on the other hand. The terminals register in a suitable manner at a central administration entity, for example with the type of terminal, the type of communication possible with this terminal, and other information. The registration can take place from the terminal itself or by a third entity.

As soon as an application (for example a service) requires information on terminals, it can interrogate the central entity for this information.

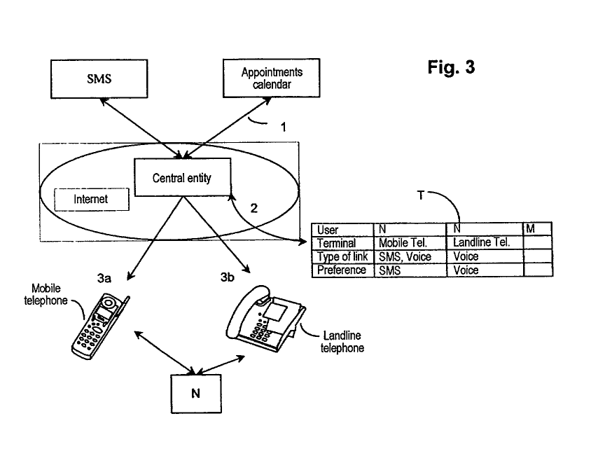

FIG. 3 represents an exemplary application. A user N has a mobile telephone (terminal A from FIG. 1) which supports the short message service SMS (application 1), and a normal landline telephone (terminal B). The user N also uses a calendar application appointments calendar (application 2) in which he has entered at least one appointment.

The user N (or his/her mobile telephone, landline telephone terminals, respectively) are active and have registered with the central entity according to the invention in the network, Internet. This is stored, for example, in a table T and other solutions such as databases are known to the expert.

The calendar application monitors appointments and reminder times and informs the user N about when the appointment in question has approached. For this purpose, the application contacts the user.

The application then turns to the central entity 1 and obtains a list of terminals at which it can reach the user 2. From the list of terminals, the application determines which two terminals are registered. One is a mobile telephone which can be activated via the SMS or a voice link and the other one is a landline telephone for which a voice link can be used. In addition, the user can previously set his/her preference between the short message service or a voice message at the mobile terminal.

In the example, the application is configured in such a way that it notifies the user in different ways. Thus, it sends the appointment information as a short message to the address of the mobile terminal, 3a, and, in parallel, sets up a telephone link to the landline telephone of the user, 3b, in order to announce to him/her the appointment information.

What is claimed is:

1. A method for administering terminals in communication networks, comprising:
registering at least one terminal with a central registration entity;
communicating at least one application with the at least one terminal;
performing an inquiry at the central registration entity; and
performing at least one action on the basis of the result of the inquiry.

2. The method as claimed in claim 1, wherein the registering of the terminal with the central registration entity is not carried out by the terminal to be registered.

3. The method as claimed in claim 1, wherein registration information is updated.

4. The method as claimed in claim 1, further comprising:
performing the inquiry for the user of the terminals by the application; and
supplying a list of terminals allocated to the user back to the application.

5. The method as claimed in claim 4, wherein an interrogation is permitted if the application has authority for the interrogation.

6. The method as claimed in claim 3, wherein in the registration information, preferences relating to the terminals are specified as:
an order of priority in which individual terminals are to be addressed,
data formats to transmit voice and/or data to the corresponding terminal, and
transmission standards for the transmission.

7. The method as claimed in claim 4, wherein the application decides from the registration information supplied back which terminal establishes contact.

8. The method as claimed in claim 7, wherein the application establishes contact with a number of terminals.

9. A device for administering terminals in communication networks, comprising:
at least one terminal registered with a central registration entity; and
at least one application to communicate with the at least one terminal,
the application performs an inquiry at the central registration entity, and
the application performs at least one action on the basis of the result of the inquiry.

10. The device as claimed in claim 9, wherein the registering of the terminal with the central registration entity is not carried out by the terminal to be registered.

11. The device as claimed in claim 9, wherein registration information is updated.

12. The device as claimed in claim 9, wherein the application perfoms the inquiry for the user of the terminals, and supplying a list of terminals is allocated to the user is supplied back to the application.

13. The device as claimed in claim 12, wherein an interrogation is permitted if the application has authority for the interrogation.

14. The device as claimed in claim 11, wherein in the registration information, preferences relating to the terminals are specified as:
an order of priority in which individual terminals are to be addressed,
data formats to transmit voice and/or data to the corresponding terminal, and
transmission standards for the transmission.

15. The device as claimed in claim 12, wherein the application decides from the registration information supplied back which terminal establishes contact.

16. The device as claimed in claim 15, wherein the application establishes contact with a number of terminals.
